(19) United States
(12) Patent Application Publication
(10) Pub. No.: US 2024/0403980 A1
(43) Pub. Date: Dec. 5, 2024

(54) Systems and Methods for a Subscription-Based Brokerage Model for Real Estate Brokerages

(71) Applicant: Stephen Ray Thomas, Salinas, CA (US)

(72) Inventor: Stephen Ray Thomas, Salinas, CA (US)

(21) Appl. No.: 18/329,392

(22) Filed: Jun. 5, 2023

(51) Int. Cl. G06Q 50/16

(52) U.S. Cl. CPC G06Q 50/16

(57) ABSTRACT

The subscription-Based Brokerage Model for Real Estate Brokerages introduces a novel approach to the traditional commission-based structure in the real estate industry. This innovative model enables agents to select and subscribe to a brokerage through a plan selection in exchange for a subscription fee, receiving up to their full commission instead of adhering to a commission-split arrangement. These plans provide services and benefits tailored to the needs and preferences of real estate agents, including essential resources. Leveraging digital platforms, agents can easily subscribe, access services, communicate with clients, and track their performance. By offering a subscription-based alternative to the traditional commission-based structure, the Subscription-Based Brokerage Model brings greater flexibility and cost control for agents. It empowers agents to focus on providing exceptional service to clients and expanding their business. Inspired by subscription services, the Subscription-Based Brokerage Model facilitates collaboration and support between agents, introducing a transformative paradigm in the real estate industry. With subscription-based options and a wide array of services, this model revolutionizes the agent-broker relationship, empowering agents in the dynamic real estate market.

### CROSS-REFERENCE TO RELATED APPLICATIONS

This application claims priority to and incorporates by reference the entire contents of the following co-pending application:

[Related Application 1]: Application No. [63/326,211], titled “Real Estate Transaction Subscription Method,” filed on Mar. 31, 2022, by the first named inventor and applicant, Stephen Ray Thomas. The application was filed through his attorney at the time, James Bowman, with customer number 163302. The filing was conducted through electronic file with EFS ID 5370731 and confirmation number 4508. An evidence of electronic acknowledgement receipt has been included in this file.

No other related applications have been filed by the inventor and applicant Stephen Ray Thomas.

### STATEMENT REGARDING FEDERALLY SPONSORED RESEARCH OR DEVELOPMENT

Not Applicable

### THE NAMES OF THE PARTY TO A JOINT RESEARCH OR DEVELOPMENT

Not Applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable

### STATEMENT REGARDING PRIOR DISCLOSURES BY THE INVENTOR OR A JOINT INVENTOR

Not Applicable

### BACKGROUND OF THE INVENTION

The present invention introduces a groundbreaking method that revolutionizes the real estate industry by implementing a subscription-based brokerage model. This innovative approach transforms the traditional relationship between real estate agents and their brokerages, offering an alternative to the conventional commission split model. Inspired by the disruptive impact of streaming services in the entertainment industry, this method brings about a paradigm shift by enabling real estate agents to subscribe to a brokerage instead of paying commission splits. By embracing this subscription-based model, agents gain greater control and flexibility, empowering them to focus on providing exceptional service to clients and expanding their business. This transformative approach represents a significant advancement in the dynamic real estate market.

### Field of the Invention

The present invention operates within the field of real estate brokerage models. Specifically, it pertains to a novel subscription-based approach that transforms the relationship between real estate agents and brokerages. This invention addresses the challenges and limitations of traditional commission-based models by introducing a subscription-based framework inspired by successful subscription services in other industries. The inventive field encompasses the restructuring of financial arrangements and service delivery mechanisms within the real estate industry to provide agents with enhanced services, financial stability, flexibility, and collaborative opportunities. By offering a new way for agents to engage with brokerages, this invention aims to revolutionize the real estate industry and create a more efficient and rewarding ecosystem for agents and brokerages to thrive in the modern real estate landscape.

The disclosed invention was conceived and developed by Stephen Ray Thomas.

### Description of Related Art Including Information Disclosed Under 37 CFR 1.97 and 1.9

In the field of real estate brokerage, various methods and systems have been employed to facilitate the relationship between real estate agents and brokerages. Traditionally, the commission-based structure has been the prevalent model, where agents share a percentage of their commission with the brokerage in exchange for the services and support provided.

However, recent developments in the industry have led to the emergence of alternative models, such as the Subscription-Based Brokerage Model. This model introduces a subscription-based approach, offering real estate agents the option to subscribe to a brokerage rather than following a commission split arrangement.

The Subscription-Based Brokerage Model solves several problems faced by real estate agents, providing them with more flexibility, control, and the opportunity to retain up to their full commission on all their real estate transactions. By choosing a subscription plan that aligns with their business goals, agents can have greater control over their earnings and tailor their payment structure to suit their individual needs.

The traditional commission-based structure often limits the agent's ability to keep their full commission, as a portion is shared with the brokerage. However, with the Subscription-Based Brokerage Model, agents can select a subscription plan that allows them to retain their entire commission, ensuring that their hard work and efforts are rewarded accordingly.

Furthermore, the model offers agents more flexibility in terms of how they receive their commissions. Depending on the subscription plan chosen, agents can either receive their commission directly from the escrow company or have the brokerage handle the distribution. This flexibility allows agents to align their commission payment preferences with their chosen subscription plan.

The Subscription-Based Brokerage Model also addresses the need for real estate agents to have access to a comprehensive range of resources and support. Through their subscription, agents gain access to marketing tools, client management systems, lead generation assistance, technology platforms, training programs, and legal resources. This level of support empowers agents to enhance their business operations, improve client service, and ultimately achieve greater success in the competitive real estate market.

In summary, the Subscription-Based Brokerage Model offers a solution to the challenges faced by real estate agents in traditional commission-based structures. By providing flexibility, control, and the opportunity to retain full commissions, this model revolutionizes the agent-brokerage relationship, empowering agents and optimizing their earning potential.

### BRIEF SUMMARY OF THE INVENTION

The present invention introduces a subscription-based brokerage model that revolutionizes the real estate industry. Departing from the traditional commission-based approach, this innovative method allows real estate agents to subscribe to a brokerage, similar to popular subscription services in other industries. By subscribing, agents gain greater flexibility, financial stability, and control over their business. In addition, this subscription-based model provides agents with access to comprehensive services and benefits tailored to their needs, including marketing support, client management tools, lead generation, training programs, technology platforms, and legal resources. The invention aims to transform the dynamics between agents and brokerages, fostering collaboration and mutual success. By leveraging the advancements of subscription business models, this invention presents an unprecedented opportunity to enhance the real estate industry for agents, brokerages, and clients alike.

### BRIEF DESCRIPTION OF THE SEVERAL VIEWS OF THE DRAWING(S)

The Subscription-Based Brokerage Model for Real Estate Brokerages can be visually represented through a series of drawings that illustrate its key components and functionalities. The following formats and structures for the drawings are:

FIG. 1 Overall System Architecture. This drawing provides an overview of the Subscription-Based Brokerage Model, showcasing the main components and their interconnections. It includes labeled blocks representing the real estate agent, real estate brokerage, escrow company, and may include other relevant entities involved in the model. Arrows or lines indicate the flow of transactions and communication between these entities.

FIG. 2 Real Estate Agent Subscription Process. This drawing focuses on the subscription process for real estate agents. It illustrates the steps involved, starting with the agent's access to the brokerage's subscription platform. The drawing includes screens and interfaces showing the available subscription plans, their features, and associated costs. Arrows or sequential numbering indicate the agent's selection process and the subsequent affiliation with the brokerage.

FIGS. 3 and 4 Real Estate Transaction Flows. These drawings depict the flow of a real estate transaction within the Subscription-Based Brokerage Model. It includes labeled entities such as buyers, sellers, agents, and escrow companies. These drawings showcase how the commission is handled based on the agent's chosen subscription plan. For instance, FIG. 3 illustrates the commission being sent to the brokerage and subsequently delivered to the agent based on their subscription plan, while FIG. 4 shows the escrow company sending the commission directly to the agent.

FIG. 5 Resources and Support. This drawing highlights the resources and support available to real estate agents through the subscription model. It showcases tools such as marketing platforms, client management systems, lead generation assistance, training programs, and legal resources. The drawing includes icons or visual representations of these resources, along with labels to indicate their functionality and benefits to the agents.

### DETAILED DESCRIPTION OF THE INVENTION

In the following description, numerous specific details are provided to enhance the understanding of the present invention's subscription-based brokerage model. However, it will be evident to those skilled in the art that the present invention may be practiced without some or all of these specific details. In other instances, well-known features of traditional brokerage models have not been described to avoid obscuring the essence of the present invention.

The invention refers to a Subscription-Based Brokerage Model for Real Estate Brokerages. This innovative model aims to transform the traditional relationship between real estate agents and brokerages by introducing a subscription-based approach. By subscribing to a brokerage, real estate agents gain access to a range of services and benefits, replacing the conventional commission-based structure. The detailed description outlines the various aspects of this subscription-based brokerage model.

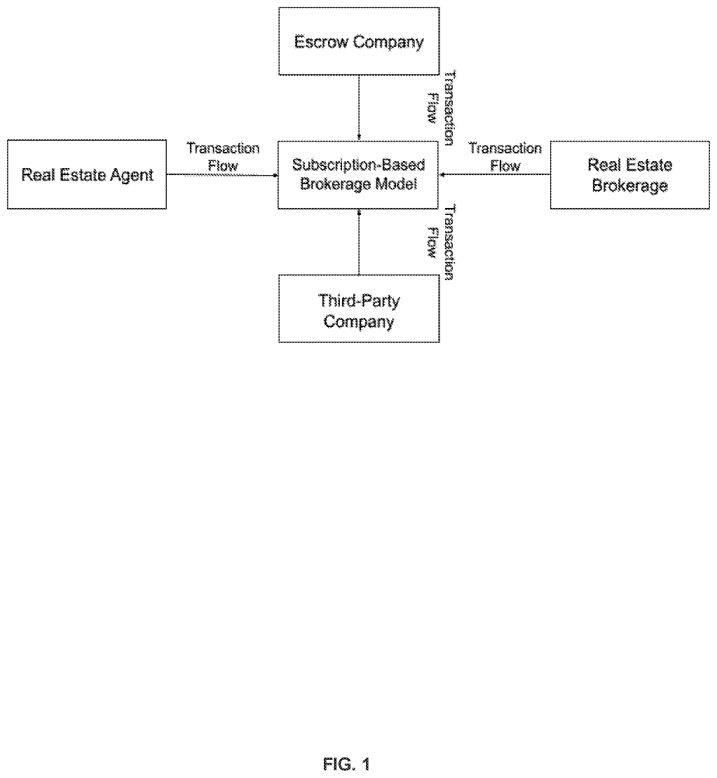

As shown in FIG. 1, in a real estate transaction through the subscription-based real estate model, there are three main entities involved: the real estate agent, the real estate brokerage, and the escrow company. In order to gain a comprehensive understanding of the subscription-based real estate brokerage method and its impact to real estate agents, it is essential to familiarize ourselves with the workings of the real estate industry.

A real estate agent is a person who helps people or client buy, sell, or rent houses, apartments, land, among other properties for either residential or commercial use in exchange of a commission charged to the client and then splitted between the Real Estate Agent and Brokerage. Real estate agents have knowledge about the housing market, property values, and legal procedures involved in buying or selling real estate.

A real estate brokerage is a company or agency that employs real estate agents in exchange of a commission split charged by the brokerage through the commission charged by the agent to the client after a transaction is completed. Typically, the commission earned is shared between the agent and the brokerage according to a predetermined percentage or agreement. The commission split allows the brokerage to cover their operational costs and provide support.

Escrow refers to a neutral third party or a company in real estate transactions that acts as a safeguard for the money and documents involved. When someone buys or sells a property, they may deposit their funds or documents into an escrow account. The escrow company holds these items until the transaction is completed and all agreed-upon conditions are met. Once everything is in order, the escrow company releases the funds or documents to the appropriate parties, such as the seller, buyer, or the real estate brokerage. After the brokerage receives the full commission, they will initiate a commission split, where they retain their portion and distribute the agent's portion accordingly.

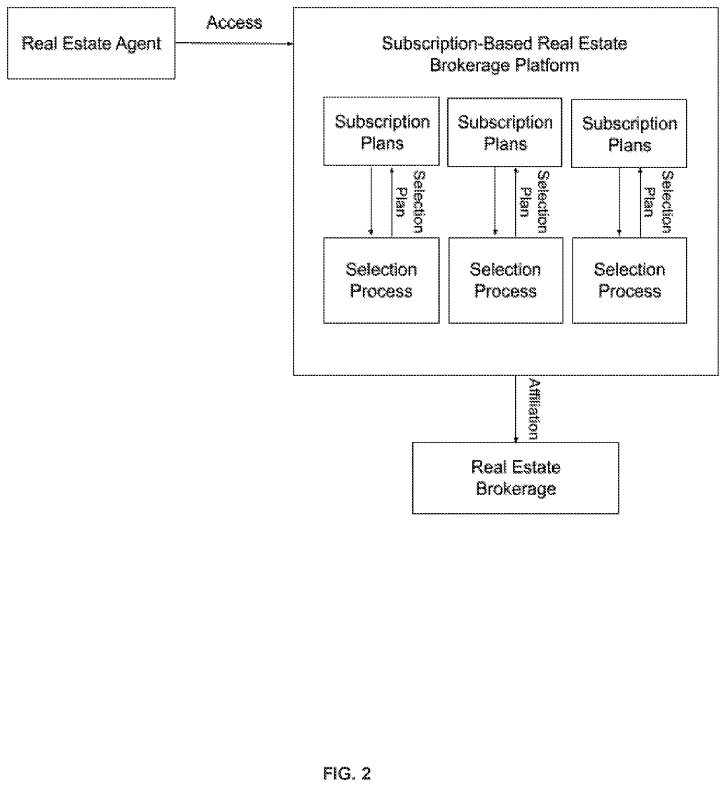

In the context of the invention and as shown in FIG. 2, the Subscription-Based Brokerage Model revolves around the process by which real estate agents join a brokerage and select a subscription plan and pay a recurring subscription fee to the brokerage. This predictable revenue stream provides agents with greater financial control and stability will agents to retain up to their full commission without the need for a commission split arrangement, eliminating the uncertainty associated with fluctuating commission-based incomes. Agents can select a subscription plan that suits their budget and business requirements, thereby enhancing their financial stability and flexibility.

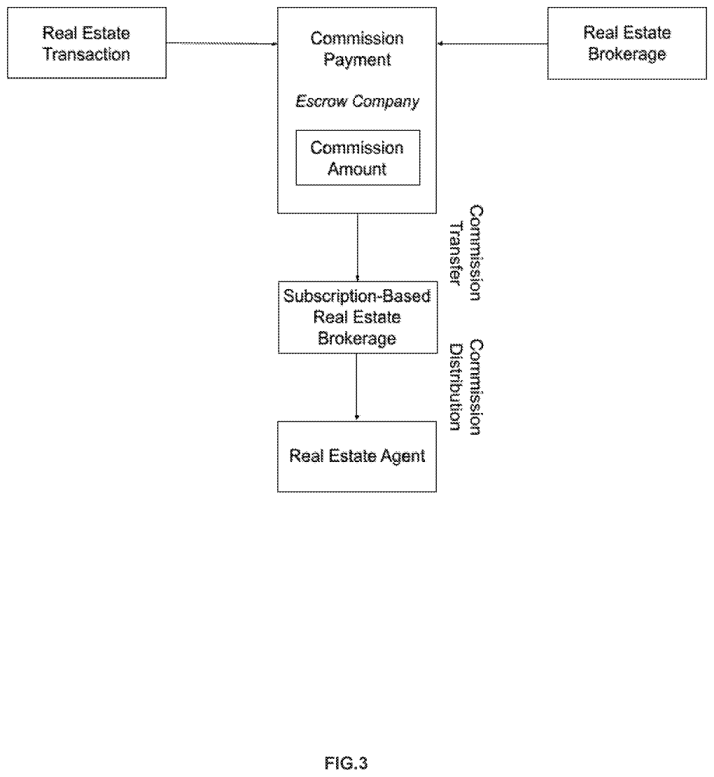

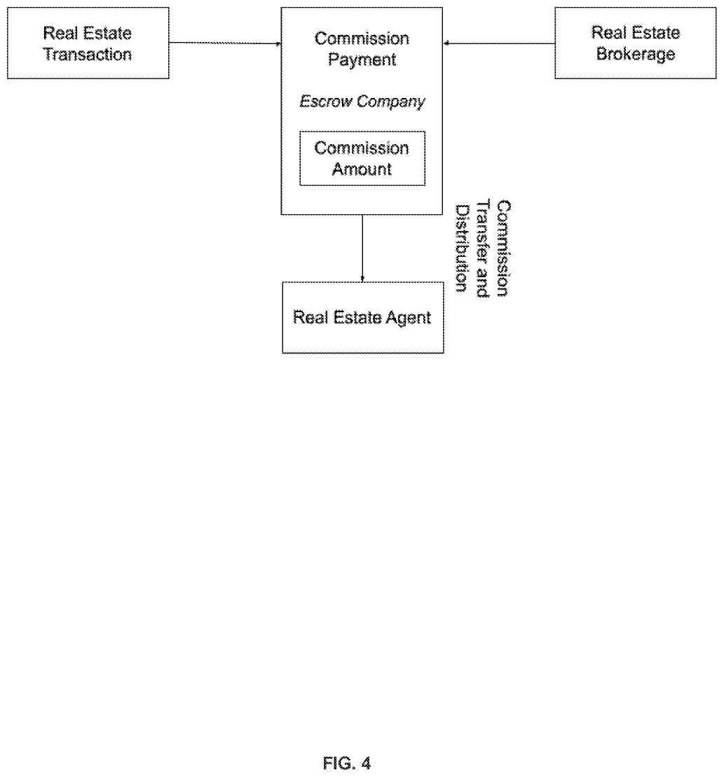

The escrow company plays a role in the financial aspect of the transaction, ensuring that the agent receives up to their full commission based on their chosen subscription plan by either sending the commission to the brokerage and subsequently delivered to the agent as shown in FIG. 3, or by sending the commission directly to the agent as shown in FIG. 4 without the need of the brokerage's distribution.

These subscription plans offer real estate agents the opportunity to keep their full commission on all their real estate transactions, eliminating the need to divide the commission through a split arrangement with the brokerage.

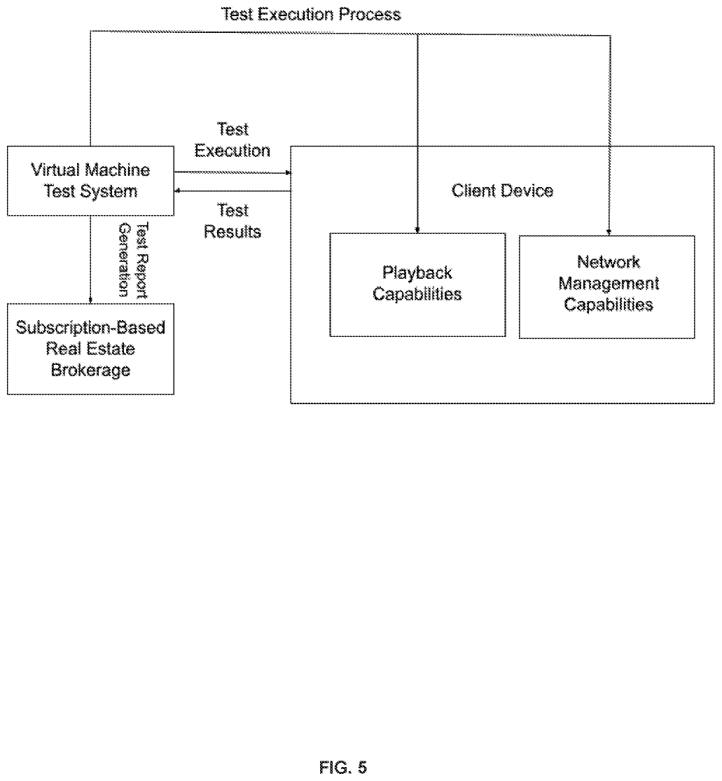

Also, as shown in FIG. 3, FIG. 4, and FIG. 5, depending on the chosen subscription tier, agents may receive benefits such as marketing support, client management tools, lead generation assistance, access to technology platforms, training programs, legal resources, access to client databases, technology platform to streamline operations and improve customer services, and more. The subscription plans allow agents to customize their experience and align it with their unique business objectives. The plans also provide agents comprehensive services, resources, and support to enhance their productivity and success in the real estate industry.

Moreover, collaboration and support are key elements of the subscription-based brokerage model. By subscribing to a brokerage, agents and the brokerage establish a partnership with shared goals and interests. The collaborative relationship between agents and the brokerage creates a mutually beneficial environment for both parties, and overall industry.

To further explain the Subscription-Based Brokerage Model, this invention addresses the challenges and limitations of traditional commission-based models by introducing a subscription-based framework inspired by successful subscription services in other industries (e.g., Netflix).

With Netflix, users have the flexibility to choose a subscription plan that suits their entertainment needs. By paying a subscription fee, they gain access to a wide selection of movies and shows, enjoying unlimited streaming and a range of services and benefits provided by Netflix.

In a similar manner, the Subscription-Based Brokerage Model for Real Estate Brokerage offers real estate agents the opportunity to choose a subscription plan tailored to their specific requirements. By paying a subscription fee, agents can access a comprehensive set of services and benefits offered by the brokerage, while also having the potential to obtain up to their full commission on real estate transactions.

Just as Netflix subscribers enjoy the freedom to watch full movies and shows, real estate agents who opt for the Subscription-Based Brokerage Model gain the advantage of obtaining their full commission earnings. In addition, the subscription fee grants them access to valuable resources and support from the brokerage, including marketing tools, training programs, administrative assistance, networking opportunities, and legal resources. These benefits enhance their professional capabilities and enable them to provide exceptional service to their clients. By aligning their subscription plan with their specific business goals, real estate agents can take advantage of the Subscription-Based Brokerage Model's innovative approach to commission handling. This model ensures that agents have the potential to receive their full commission directly or through transparent and efficient mechanisms facilitated by the brokerage, eliminating unnecessary intermediaries and delays.

In summary, the Subscription-Based Brokerage Model for Real Estate Brokerage operates on a similar principle to Netflix's subscription-based model. While Netflix offers access to an extensive library of movies and shows, the brokerage's model empowers real estate agents by providing a subscription-based framework that enables them to obtain up to their full commission while accessing a range of services and benefits. This comparison highlights the inventive nature of the method and its potential to revolutionize the real estate industry by offering agents greater control over their earnings and access to valuable resources.

The operational implementation of the subscription-based brokerage model is facilitated through digital platforms and systems. Web portals, mobile applications, and online platforms serve as the primary tools for agent subscriptions, service delivery, and communication between agents, brokerage, and other parties. These digital resources enable agents to manage their subscription, access services, communicate with clients, schedule property viewings, and monitor their business performance. The brokerage leverages advanced customer relationship management (CRM) systems to maintain comprehensive client profiles and deliver personalized services.

In summary, the Subscription-Based Brokerage Model for Real Estate Brokerages revolutionizes the real estate industry by introducing a subscription-based approach. The detailed description highlights the advantages of this model, including enhanced financial stability, flexibility, and collaboration opportunities for real estate agents. The subscription plans offer a range of services and benefits tailored to agents' needs, while digital platforms streamline operations and facilitate communication. By adopting this innovative model, real estate agents and brokerages can thrive in the evolving real estate landscape, benefiting agents, brokerages, and ultimately, the clients they serve.

1. A method for implementing a subscription-based brokerage model in the real estate industry, comprising:
1. Providing a plurality of subscription plans for real estate agents, each plan offering different levels of services and benefits.
2. Enabling real estate agents to subscribe to a brokerage to a chosen subscription plan by paying a recurring subscription fee.
3. Offering up to full commission, marketing support, client management tools, lead generation assistance, technology platforms, training programs, and legal resources to subscribed agents.
4. Facilitating collaboration and support between subscribed agents and the brokerage through ongoing training programs, marketing assistance, legal resources, and access to client databases.
5. Implementing digital platforms and systems for agent subscriptions, service delivery, communication, and performance tracking.

2. A subscription-based brokerage system for real estate brokerages, comprising:
1. A subscription plan management module configured to provide multiple subscription plans with varying services and benefits.
2. A subscription management module enabling real estate agents to subscribe to a chosen plan by paying a recurring subscription fee.
3. A resource allocation module allocating marketing support, client management tools, lead generation assistance, technology platforms, training programs, and legal resources to subscribed agents.
4. A collaboration module fostering collaboration and support between subscribed agents and the brokerage through ongoing training programs, marketing assistance, and access to client databases.
5. Digital platforms and systems facilitating agent subscriptions, service delivery, communication, and performance tracking.
